(19) United States
(12) Patent Application Publication
(10) Pub. No.: US 2008/0074863 A1
(43) Pub. Date: Mar. 27, 2008

(54) ELECTROLUMINESCENT ILLUMINATED GAUGE AND COMPONENTS AND METHODS THEREFOR

(76) Inventor: Aaron J. Golle, Shakopee, MN (US)

Correspondence Address: SCHWEGMAN, LUNDBERG & WOESSNER, P.A., P.O. BOX 2938, MINNEAPOLIS, MN, 55402, US

(21) Appl. No.: 11/860,385

(22) Filed: Sep. 24, 2007

Related U.S. Application Data
(60) Provisional application No. 60/846,806, filed on Sep. 22, 2006.

(51) Int. Cl. G01D 11/28

(52) U.S. Cl. 362/29

(57) ABSTRACT

An electroluminescent illuminated gauge which can be used by technicians in all conditions of weather and situations involving poor visibility due to lighting is disclosed. The electroluminescent illuminated gauge is very useful to illuminate a gauge, in which the dial is non-illuminating. The front side of the portable electroluminescent illuminated gauge is illuminated. The front side of the dial lamp may be fixed on the front side of a gauge using a double sided adhesive, which facilitates the technicians to have free hands to perform any necessary work, without holding a torch with one hand.

### TECHNICAL FIELD

The present invention pertains generally to methods and devices pertaining to lamps and more particularly to methods and devices pertaining to electroluminescent illuminated gauges to illuminate gauges, more particularly in situations involving poor visibility due to lighting or weather conditions.

### BACKGROUND

Technicians working in the maintenance departments of industries have to work in all conditions of weather and situations involving poor visibility due to lighting. They have to record the readings in gauges such as pressure gauges. Most gauges currently come with some type of reflective dial. These are somewhat easily seen during daylight hours or when illuminated with a light at night or during diminished light conditions. However, many of these gauges are located on devices in the field, where a technician would have to find some way to illuminate the gauge during night time or under diminished light conditions in order to check a pressure, like that of a Freon in an automobile, a sprayer attached to a tractor spreading chemicals onto a field, a utility worker checking pressure on a gas line connected to a home, a gauge fixed on a medical device, or a gauge fixed on a piece of farm equipment.

### DESCRIPTION OF DRAWINGS

FIG. 1 shows a plan view of an electroluminescent illuminated gauge according to an example embodiment of the inventive subject matter.

FIG. 2A shows a front perspective view of the electroluminescent illuminated gauge shown in FIG. 1 according to an example embodiment of the inventive subject matter.

FIG. 2B shows a partial cross-sectional view taken along the line 2B of FIG. 2A.

FIG. 3A shows a front view of a gauge lamp;

FIG. 3B shows a back view of a gauge lamp including connections to a source of power;

FIG. 4 illustrates a side view of an embodiment of an EL gauge lamp including an adhesive layer;

FIG. 5 shows a view of a pair of electroluminescent illuminated gauges.

FIG. 6 illustrates a two gauge valve according to one example embodiment of the inventive subject matter.

### DETAILED DESCRIPTION

In the following detailed description of the inventive subject matter, reference is made to the accompanying drawings which form a part hereof, and in which is shown, by way of illustration, specific embodiments in which the inventive subject matter may be practiced. In the drawings, like numerals describe substantially similar components throughout the several views. These embodiments are described in sufficient detail to enable those skilled in the art to practice the inventive subject matter. Other embodiments may be utilized and structural, logical, and electrical changes may be made without departing from the scope of the present invention.

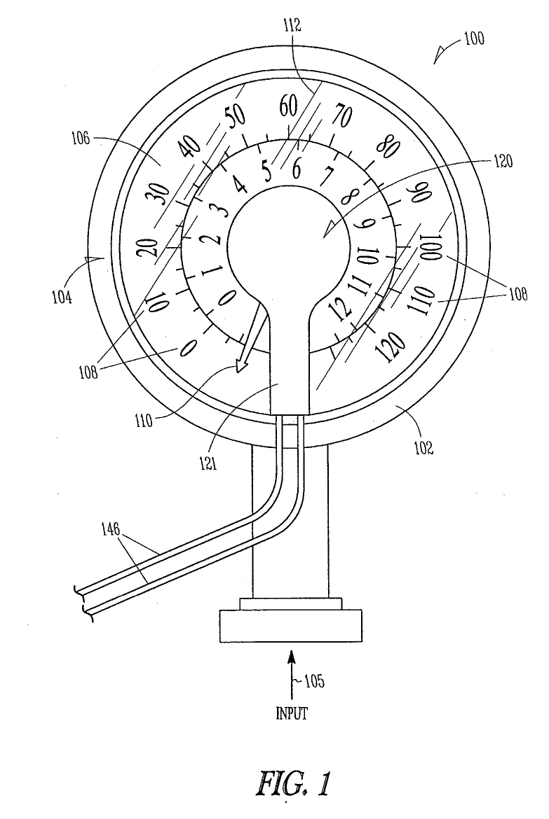

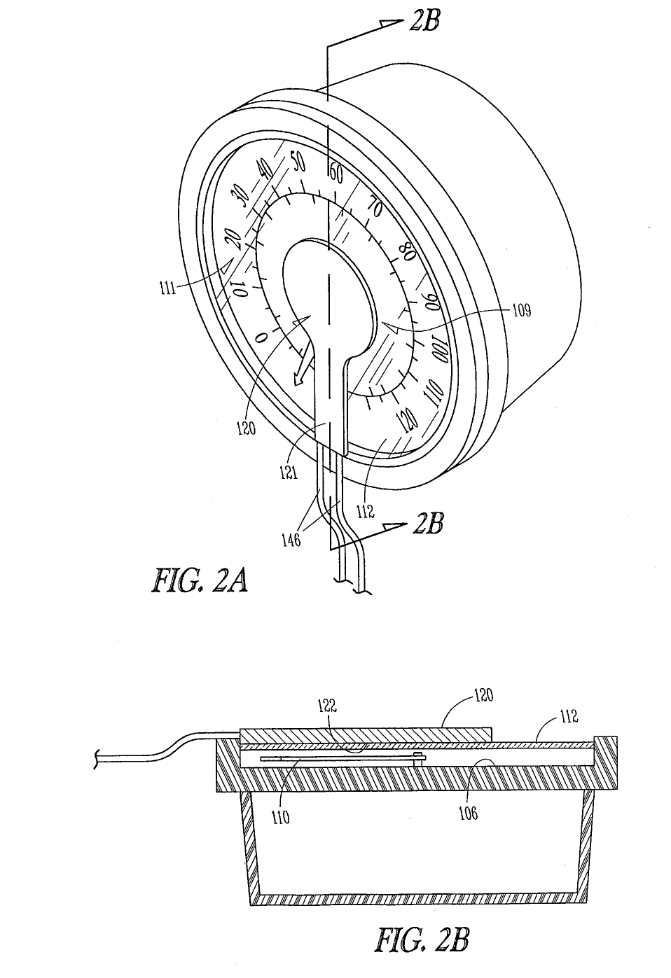

Referring now to FIGS. 1, 2A and B, 3A, 3B and 4, there are illustrated various views of an electroluminescent (EL) illuminated gauge 100, according to an example embodiment of the inventive subject matter. Gauge 100, in one example embodiment, is a pressure gauge, and includes a housing 102 and a gauge display assembly 104. Gauge display assembly 104 includes a gauge face 106 including measurement scale indicia 108, a gauge indicator 110, and optionally a transparent gauge lens or cover 112. Indicator 110 is driven by the measurement mechanism (not shown), which receives an input 105, such as the pressure of a liquid or gas, and activates or controls the indicator 110 in response thereto to provide a desired gauge function.

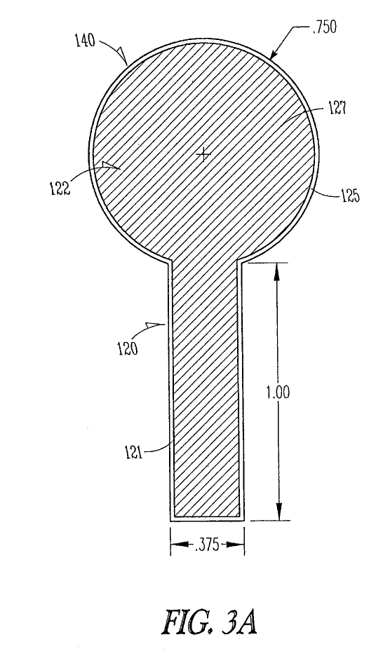

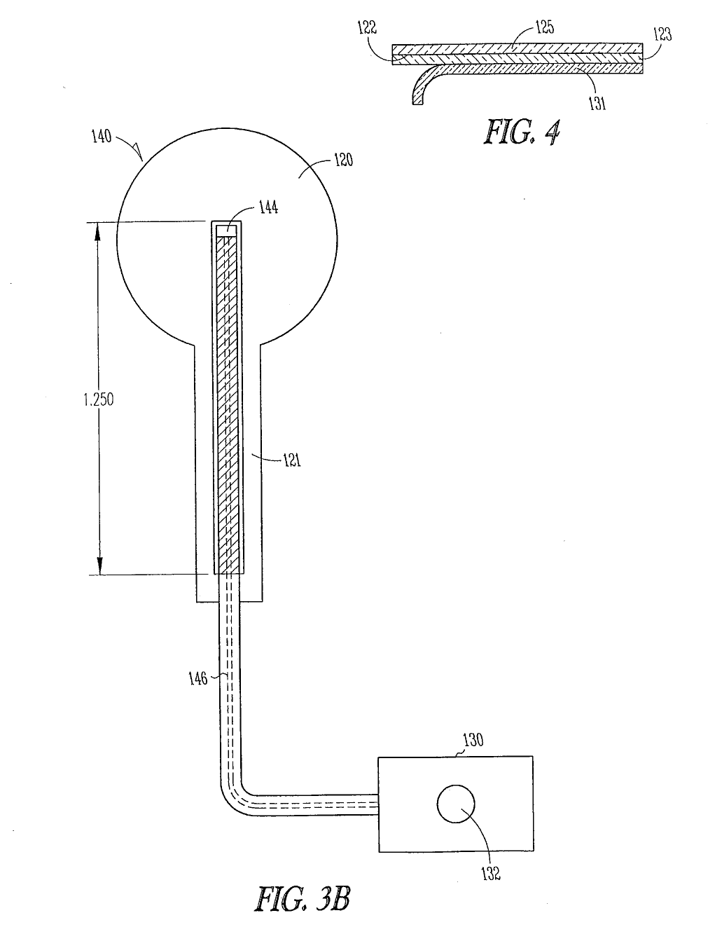

Attached to transparent cover 112 is an EL gauge lamp unit 120. Gauge lamp unit 120 includes an EL lamp 125 having a surface area 127 (highlighted in FIG. 3A with hash marks) that glows with EL light, when activated, on the front side 122 of lamp 125. Side 122 is attached to transparent cover 112, for example with a transparent adhesive 123 (see FIG. 4), so that the illumination from the side 122 glows down through the transparent cover 112 onto the gauge face 106. Accordingly, the face 106 of the gauge is illuminated. According to one example embodiment, where the gauge face 106 is circular in shape, the side 122 is also generally circular or oval in shape, and is sized such that it can be applied to the cover 112 so that its center aligns with the center of the circular gauge face and so that it is of a diameter that does not substantially interfere with the reading of the gauge indicia 108. According to one example embodiment, gauge lamp unit is substantially flat or planar, and is made of flexible material so that it can flex to conform to any surface it is attached to. Such flexible material may include a flexible printed circuit substrate.

In one example embodiment, the gauge lamp unit 102 may overlay or cover some portion of the gauge indicia 108 within an area 109 closest to the center of the dial, but not the indicia 108 on the outer area 111 of the face of the gauge. Still further, according to one example embodiment, gauge lamp unit 120 may include a stem 121 that extends from the main body of the unit 120. Leads 146 (for example but not by way of limitation six to eight inches long) connect to, as shown in FIG. 3B, electrodes on the EL lamp unit 120, which in turn may be connected to an electrical pack 130 including electronics and power for activation the EL lamps, such as an inverter and a rechargeable or non-rechargeable battery. Electrical pack 130 further includes a switch control 132 that can be used to switch power on and off to the EL lamp 125. According to one embodiment, the switch 132 may be a push button switch that includes a timer and such that the switch automatically turns off after a pre-set delay period. According to another embodiment, the switch 132 may be activated by a proximity sensor that detects the proximity of an object, such as a user. According to another example embodiment, switch 132 then automatically activates the gauge for a predetermined delay period, and then shuts off automatically.

According to another example embodiment, as shown in FIG. 4, the front surface 122 of the EL lamp 125 is covered with a double-sided adhesive 123 with a peel-off cover 131. According to one example method, the lamp unit 120 is applied to a gauge 100 by peeling off cover 131 from the adhesive 123 and pressing the EL lamp 125 onto the transparent cover 112 of the gauge 100.

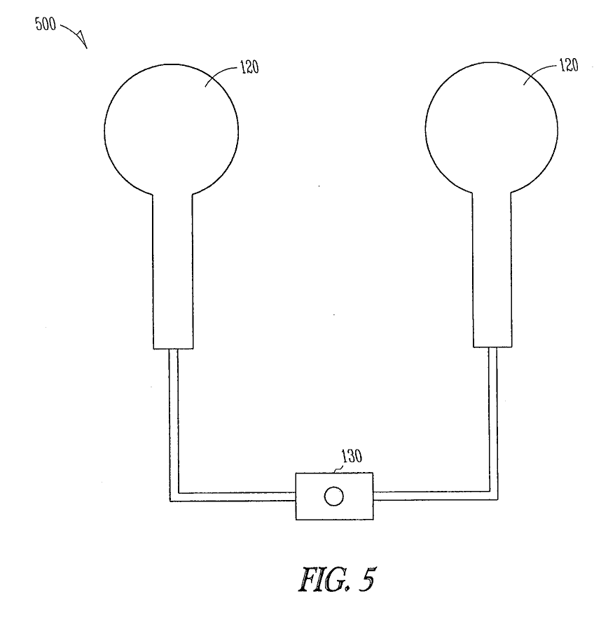

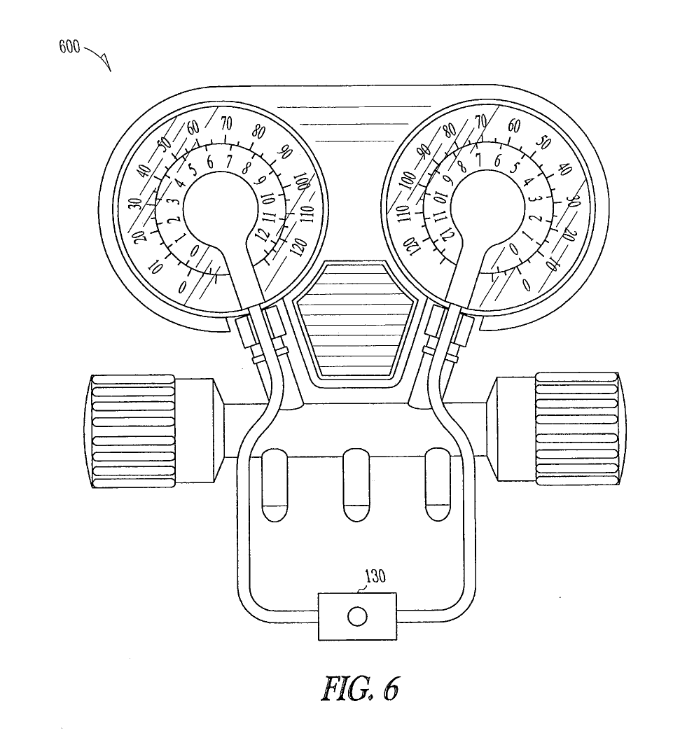

Referring now more specifically to FIG. 3A and FIG. 3B, there is illustrated the construction of an EL gauge lamp unit 120 according to one example embodiment of the inventive subject matter, wherein FIG. 3A illustrates the front, glowing side of lamp unit 120, and FIG. 3B illustrates the back of EL gauge lamp unit 120. According to one example embodiment, the EL lamp uses high bright blue phospher, to provide a blue tinted lighting for the gauge. EL gauge lamp unit 120 has a round end 140 and a narrower rectangular stem 121 end, and, in one embodiment, the lamp surface area 127 extends across substantially the entire area of the lamp unit 120, including both ends 140 and the stem end 121, and in-between the ends. In one embodiment, electrical power is supplied to the EL lamp electrodes 144 accessible at the center of the round end 140. Wire leads 146 run down the stem 121 and, in one example embodiment, are cured to the lamp unit 120 with a UV cured adhesive. Leads 146 are crimped to the respective electrodes 144 to supply power to the lamp unit 120. As illustrated in FIG. 5, one or more lamp units 120 may be connected by leads 146 to a power pack unit 130, which in one embodiment may include an inverter and a battery, such as a size 2450 battery. A dual lamp unit 500 such as shown in FIG. 5 may be used to illuminate a two-face gauge 600 such as shown in FIG. 6. In one embodiment, a lamp unit 120 end 140 may have a diameter of about 0.75 inches or equivalent metric size, and the stem may be about 1 inch long and 0.375 inches wide or equivalent metric size.

Although in one example embodiment, the EL light provided by a lamp unit 120 may be blue tinted, any other color light may be used. In one example embodiment, a soft tinted light may be preferred. In another embodiment, the indicia 108 on a gauge may be phosphorescent or another chemical composition that may glow under EL lighting conditions to enhance the visibility of the gauge face even more.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. It is to be understood that the above description is intended to be illustrative, and not restrictive. Combinations of the above embodiments and other embodiments will be apparent to those of skill in the art upon reviewing the above description. The scope of the inventive subject matter includes any other applications in which the above structures and fabrication methods are used. The scope of the inventive subject matter should be determined with reference to the appended claims, along with the full scope of equivalents to which such claims are entitled.

What is claimed is:

1. A device comprising:
a gauge having at least one face including gauge measurement indicia, at least one indicator and a transparent cover member; and
a planar electroluminescent (EL) lamp member affixed to the transparent cover member to illuminate the face.

2. The device of claim 1, wherein the planar lamp element is adhered to the gauge with a double-sided adhesive.

3. The device of claim 1 wherein the gauge includes a front side having a circular surface or rectangular surface illuminated by the electroluminescent lamp member.

4. A method comprising attaching an electroluminescent lamp to the transparent cover of a gauge with an adhesive so that a surface area of the lamp shines through the cover when the lamp is illuminated.

5. An article comprising a planar electroluminescent (EL) lamp member shaped to cover a center portion of a gauge face but not cover other portions of the gauge face used to determine a measurement.

6. An article comprising a planar electroluminescent (EL) lamp member shaped to cover a center portion of a gauge face but not cover other portions of the gauge face used to determine a measurement, and further including a transparent adhesive on a lamp surface of the lamp member.
